(19) United States
(12) Patent Application Publication
(10) Pub. No.: US 2002/0117438 A1
(43) Pub. Date: Aug. 29, 2002

(54) Pressurized filtering apparatus with membrane modules

(76) Inventors: Ingo Blume, Hengelo (NL); Hendrik Dirk Willem Roesink, Borne (NL)

Correspondence Address: PEACOCK MYERS AND ADAMS P C, P O BOX 26927, ALBUQUERQUE, NM, 871256927

(21) Appl. No.: 10/075,784

(22) Filed: Feb. 13, 2002

Related U.S. Application Data
(63) Continuation-in-part of application No. 09/251,979, filed on Feb. 18, 1999, now abandoned.

(30) Foreign Application Priority Data
Feb. 20, 1998 (NL) 1008381

(51) Int. Cl. B01D 63/04

(52) U.S. Cl. 210/321.8; 210/323.2; 210/438; 210/455

(57) ABSTRACT

A filtering device comprising a pressure vessel provided with a feed connection and a filtrate connection, and one or more capillary filtration membrane modules. The membrane modules comprise an inlet coupled with the feed connection, an outlet coupled with the filtrate connection, and a filter housing provided with a membrane compartment accommodating a bundle of capillary filtration membranes. The capillary filtration membranes are cased at both ends of the membrane module in membrane holders. At least one of the membrane modules is provided with at least one feed-through conduit extending substantially in the longitudinal direction through the membrane module.

### CROSS-REFERENCE TO RELATED APPLICATIONS

This application is a continuation-in-part application of U.S. patent application Ser. No. 09/251,979, entitled “Filtering Device”, to Blume, et al., filed on Feb. 18, 1999, and the specification thereof is incorporated herein by reference.

### BACKGROUND OF THE INVENTION

1. Field of the Invention (Technical Field)

The present invention relates to methods and apparatus for filtering fluids, specifically a modular filtering system.

2. Background Art

It is known in the art to connect filter modules in series, whereby the outlet of one module is connected to the inlet of another module, so that “downstream” modules receive the discharge from “upstream” modules. Known devices commonly include a pressure vessel provided with a feed connection and a filtrate connection, and one or more filtration membrane modules. The membrane modules have an inlet coupled with the feed connection, an outlet coupled with the filtrate connection, and a filter housing provided with a membrane compartment accommodating filtration membranes.

In known series filtering devices, a number of membrane modules are serially connected in a pressure vessel, with the wall of the membrane modules, the filter housing, fitting closely to the wall of the pressure vessel. Via the pressure vessel's feed connection, the medium to be filtered, for example a liquid, enters a first open end of the capillary filtration membranes (the inlet of the membrane module) of a first membrane module in the flow direction. The filtered liquid, the permeate or filtrate, that has passed the membrane wall can exit the membrane module via its outlet, to be eventually discharged from the pressure vessel via its filtrate connection. In some versions of the pressure vessel, both the feed connection and the filtrate connection may comprise different connective points. In known systems, liquid that has not been filtered in the first module will exit the capillary filtration membranes at a second open end to be fed to an inlet of a following membrane module in the flow direction. This flow path results in a pressure reduction occurring with each successive membrane module, due to the flow resistance caused by the capillary filtration membranes. This can be reduced by using capillary filtration membranes with comparatively larger inside diameter, at the expense of the size of the available filtration surface in a membrane module. But the consequence of the pressure reduction with each consecutive membrane module is that the trans-membrane pressure across the capillary filtration membrane walls for each consecutive (in the flow direction) membrane module decreases, thereby lowering the filtration performance of each consecutive membrane module.

In addition, the capillary filtration membranes require periodic flushing to remove contamination from the membrane wall. This is done by reversing the flow direction of the liquid. The liquid will now pass through the membrane wall from the outside to the inside, carrying with it any contamination retained in and/or on the membrane wall. This liquid containing the contamination will exit the capillary filtration membranes via the first open end, after which it has to flow through the capillary filtration membranes of a following “downstream” membrane module. However, it is rather difficult in such known systems to remove the contamination from the membrane modules and the pressure vessel in this manner. This is especially the case with the membrane modules which during flushing are farthest removed from the feed connection acting as flush outlet.

The pressure drop over a membrane module also results in a reduction of the trans-membrane pressure in a single membrane module in the flow direction through the capillary filtration membranes with the flow approaching one of its ends. Due to the flow resistance caused by the capillary filtration membrane, the trans-membrane pressure will be higher at the entrance of the capillary filtration membrane than at its exit. This uneven trans-membrane pressure in the individual capillary filtration membranes lowers the filtration performance of a single module.

The present invention overcomes the disadvantages of known devices and systems.

### SUMMARY OF THE INVENTION (DISCLOSURE OF THE INVENTION)

There is provided according to the invention a filtering apparatus comprising a pressure vessel having a feed connection and a filtrate connection, and at least one capillary filtration membrane module, the membrane module having a length and comprising an inlet coupled with the feed connection, an outlet coupled with the filtrate connection, and a filter housing defining a membrane compartment accommodating a bundle of capillary filtration membranes. The capillary filtration membranes are cased at both ends of the membrane module in membrane holders, and at least one of the membrane modules comprises at least one feed-through conduit extending in the longitudinal direction throughout the length of the membrane module, the walls of the feed-through conduit preferably being made of an impermeable material. Filtration flow occurs radially from inside each capillary filtration membrane to outside each said capillary filtration membrane.

At least one of the feed-through conduits comprises a pipe located inside the membrane compartment, and the apparatus additionally may comprise a feed-through conduit annularly surrounding the membrane compartment. Preferably, the apparatus includes plurality of membrane modules in fluid serial connection to define a system. In one embodiment, the walls of the annular feed-through conduit are formed by the filter housing and a wall of the pressure vessel. A filtering apparatus according to the invention additionally may comprise spacers between the wall of the pressure vessel and the filter housing. The walls of the feed-through conduit optionally comprise a rigid material with a smooth surface.

An advantage of the invention is desirably low system pressures without impairing filter efficiency.

Another advantage is pressure equalization within modules for lower construction costs, increased efficiency, and simpler maintenance.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a schematic side view of a pressure vessel comprising several membrane modules;

FIG. 2 is a longitudinal side, or axial, sectional view of a pressure vessel comprising two different membrane modules according to the invention; and

FIGS. 3, 4 and 5 are radial cross sectional views of different embodiments of membrane modules according to the invention.

### DESCRIPTION OF THE PREFERRED EMBODIMENTS (BEST MODES FOR CARRYING OUT THE INVENTION)

The invention relates to a filtering device comprising a pressure vessel provided with a feed connection and a filtrate connection, and one or more capillary filtration membrane modules. The membrane modules have an inlet coupled with the feed connection, an outlet coupled with the filtrate connection, and a filter housing provided with a membrane compartment accommodating a bundle of capillary filtration membranes. The capillary filtration membranes are cased at both ends of the membrane module in membrane holders. In this specification and in the claims, “capillary filtration membranes” refers to tubular hollow fiber membranes, as opposed to planar sheet membranes, and the fibers being of extremely small diameter. Such capillary filtration membranes are known generally in the art, such as in U.S. Pat. No. 4,876,006 to Ohkubo et al.

In the invention, the hollow fiber membranes are bundled, that is, a plurality of many capillary filtration membranes are collected in parallel, so that fluid simultaneously enters all of the bundled membranes at the same time, and is discharged simultaneously from all the membranes. “Bundled” also suggests that the individual hollow fiber membranes are generally contiguous, as the term “bundle” is used in the '006 Patent to Ohkubo et al. The inlet ends of the plurality of membranes in the preferred embodiment a generally within a common imaginary plane and their outlet ends also preferably are in or about a second common plane.

The invention provides a filtering apparatus wherein at least one of the membrane modules is provided with at least one feed-through conduit extending substantially in the longitudinal direction through the membrane module. Depending on the specific circumstances, the option is to use only one or a few membrane modules provided with such feed-through conduit, or to apply a filtering system in which all membrane modules are provided with such feed-through conduits. The feed-through conduits must be sufficiently large so that there is little or no flow resistance, and a decline in performance due to pressure reductions is prevented.

In a preferred embodiment of the invention, the feed-through conduit is a pipe located axially inside the membrane module compartment. When more than one feed-through conduit is used, this will mean that more than one pipe is provided. The manufacture and installation of such a pipe or pipes is simple.

In another easily realizable embodiment, a feed-through conduit is provided which annularly surrounds the membrane compartment. The walls of the annular feed-through conduit may then be defined by the filter housing and a wall of the pressure vessel, thereby eliminating the need for an extra wall in the membrane module to form the feed-through conduit. In such an embodiment, it is preferred that spacers are provided between the wall of the pressure vessel and the filter housing. This allows the membrane module to be firmly positioned in the pressure vessel. The spacers may either be attached to the wall of the pressure vessel or to the filter housing.

The walls of the feed-through conduit coming into contact with the membrane compartment may be made from a porous material or from the same material as the capillary filtration membranes. Very preferably, however, the walls of the feed-through conduit are made from an impermeable rigid material with a smooth surface. Material of such character renders the feed-through conduit mechanically more stable, while the smooth, nonporous surface to a large degree prevents the accretion of solids on the walls of the feed-through conduit. By this means, the flow resistance of the feed-through conduit will increase scarcely at all with use and time. Also, with the feed-through conduit fashioned from impermeable material, the comparatively unfiltered fluid flowing therethrough is not co-mingled with the filtered material flowing out from the capillary membranes.

The invention will now be elucidated with reference to the appended drawings in which identical or similar parts are indicted by the same reference numbers.

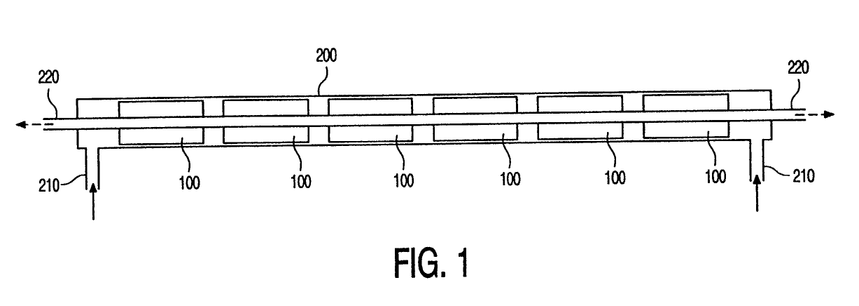

An embodiment of a pressure vessel 200 used in practice is schematically illustrated in FIG. 1. The pressure vessel 200 shown comprises six membrane modules 100, although more or fewer membrane modules may also be used without departing from the scope of the invention. If the length of the pressure vessel 200 is, for example, 6 to 8 meters, the length of the membrane modules 100 typically would be approximately 0.5 to 4 meters. Usually a membrane module will be 1.0 to 1.5 meters long. However, these lengths may vary in practice, and are not offered by way of limitation. The pressure vessel 200 shown in FIG. 1 possesses a feed connection 210 formed by two connective points, and a filtrate connection 220 formed by two connective points. During filtration, the direction of flow of liquid to be filtered is from left to right through the three membrane modules 100 at the left side of the pressure vessel, and from right to left through the three membrane modules 100 at the right side of the pressure vessel.

It is seen, however, that the axial flow of fluid through each capillary membrane is bidirectional. Fluid to be filtered enters both ends of an individual capillary membrane, and exits the membrane either by osmotic transfer radially outward through the membrane wall. This is in contradistinction to some known devices, which force fluid to be filtered radially inward through the capillary membrane walls, that is, from outside the hollow fiber into its interior. In such devices, however, efficiency may be impaired due to the fact that upon entering the membrane interior, the fluid typically flows in one direction only, toward a single open end of the membrane. Dominant pressure differentials may not occur near the open ends of the capillary membranes, allowing for impaired flow and eddy currents within the membrane, particularly near the open end. In contrast, fluid flowing through the capillary membranes of the inventive apparatus is at all times directed by a pressure bias that directs the fluid into the capillary membrane. The result is a much more efficient fluid flow, without sacrificing the benefit of exploiting the entire capillary membrane length.

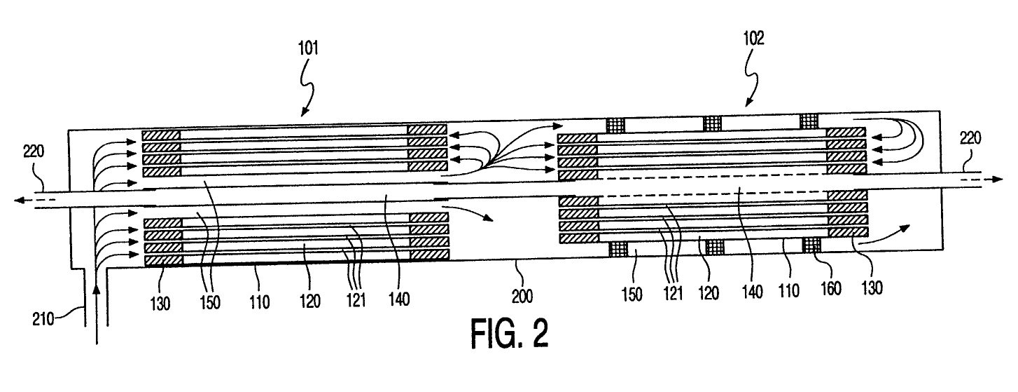

The filtering device illustrated in FIG. 2 comprises a pressure vessel 200 having a feed connection 210 for the liquid to be filtered, formed by one connective point, and a filtrate connection 220 for the filtered liquid (the permeate or filtrate), formed by two connective points. For illustration purposes, the pressure vessel 200 in FIG. 2 comprises two different membrane modules 101, 102. However, in practice the number of membrane modules will be larger, as shown in FIG. 1, and the membrane modules will be identical. It is also possible that only one membrane module is used in a pressure vessel. For good positioning of the membrane module 101 inside the pressure vessel 200, the filter housing 110 of the membrane module 101 fits closely to the inside wall of the pressure vessel 200, leaving little or no space between them. Inside the pressure vessel 200, spacers are used to position the membrane module 102 between the inside wall of the pressure vessel 200 and the filter housing 110. Inside the filter housing 110, a membrane compartment 120 comprises a bundle of capillary filtration membranes 121 which, at both ends of the membrane module 100, are cased in membrane holders 130. In practice, said capillary filtration membranes will usually be micro or ultrafiltration hollow fiber membranes. Further, a permeate discharge compartment 140 and feed-through conduits 150 are provided. The membrane holders 130 close off the space between the capillary filtration membranes 121, the filter housing 110, the permeate discharge compartment 140 and the feed-through conduits 150. In the embodiment shown, the membrane holders 130 are formed from a resin applied in the membrane module, in which resin the capillary filtration membranes 121 are embedded. In the embodiment of the membrane module shown, both ends of all the hollow fiber capillary filtration membranes remain open to receive or discharge fluid from the membranes.

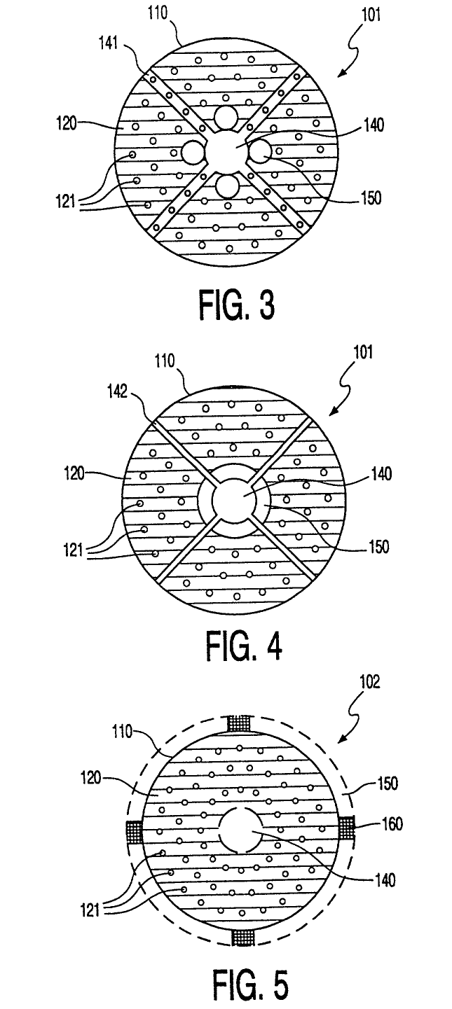

Possible cross sections of the membrane module 101, illustrated in FIG. 2 as a longitudinal section, are shown in FIGS. 3 and 4. These figures also show permeate discharge pipes 141 and permeate discharge lamellae 142 respectively. The liquid to be filtered and which, via the feed connection 210, is let in from the pressure vessel 200, will flow into the capillary filtration membranes 121. The effect of a difference in pressure over the membrane wall, the trans-membrane pressure, and the properties of the membrane, allow a portion of the liquid to pass through the membrane wall. Via the permeate discharge pipes 141 or the permeate discharge lamellae 142, such portion of the liquid, the permeate, is able to reach the permeate discharge compartment 140, and is subsequently discharged to the filtrate connection 220. In FIGS. 1 and 2 the flow of the liquid to be filtered is indicated by a solid-line arrow, and the flow of the permeate is indicated by a dashed-line arrow. The permeate discharge compartments of the various membrane modules are in communication with one another.

With the membrane modules according to the prior art, the liquid to be filtered is able to reach a following membrane module, in the flow direction, only via the capillary filtration membranes of preceding “upstream” membrane modules. If the inside diameter of the capillary filtration membranes is small, the consequence will be a considerable pressure drop over upstream membrane modules, so that the trans-membrane pressure at a following “downstream” module will be lower. In order to avoid this, the membrane module according to the invention is provided with a feed-through conduit 150 for the liquid to be filtered. Via the feed-through conduit 150 a following membrane module will receive the liquid to be filtered from a preceding membrane module.

Another advantage is that also the right-hand sides of the capillary filtration membranes (as oriented in the figures) of the membrane modules shown in FIG. 2, are supplied with liquid to be filtered. The result is an extremely constant pressure inside the individual capillary filtration membranes 121, so that the trans-membrane pressure in the longitudinal or axial direction of each individual capillary filtration membrane will decrease a negligible amount. This improves the filtration performance of the particular membrane module. In that case it may be advantageous to provide all membrane modules in a filtering system with feed-through conduits. When considering this option, an optimum must be found between a loss of membrane surface due to the incorporation of the feed-through conduit, and the elimination of pressure drops due to the addition of said feed-through conduits.

In the cross-sectional view of the membrane module 101 shown in FIG. 3, the filter housing comprises four feed-through conduits 150 in communication with the permeate discharge compartment 140. The round pipes for the permeate discharge compartment 140 and the four feed-through conduits 150 can be manufactured together with the permeate discharge pipes 141 as a functional unit, and placed in the filter housing 110. This constitutes a convenient, less expensive method of manufacture. After the unit of pipes has been placed, the capillary filtration membranes and the membrane holders can be installed. The total cross-sectional area of the feed-through conduits 150 preferably is selected to obtain an optimum for both the available membrane surface and the feed-through performance of the feed-through conduits 150. Alternatively, the feed through conduits 150 may be distributed differently in the filter housing 110. It is also possible to use more or fewer feed-through conduits.

In the membrane module 101 shown in cross section in FIG. 4, permeate discharge lamellae 142 are used to convey permeate from the membrane compartment 120 to the permeate discharge compartment 140. In this embodiment, a discharge lamella 142 is clamped between two feed-through conduits 150 to fix the discharge lamella 142. FIG. 4 shows four discharge lamellae 142 and four feed-through conduits 150. This aggregate of lamellae and feed-through conduits can also be assembled as a unit prior to being placed into the filter housing. It can also be seen that the space enclosed by the various feed-through conduits 150 forms a permeate discharge compartment 140.

The membrane module 102 is shown in FIGS. 2 and 5 in longitudinal and cross-sectional views respectively, and includes at the outside of the filter housing 110 spacers 160. By placing the membrane module 102 into the pressure vessel 200, a feed-through conduit 150 is formed by the space enclosed by the filter housing 110 and the wall of the pressure vessel 200. In this embodiment, the feed-through conduit 150 surrounds the membrane compartment 120 annularly. The spacers 160 may also be formed differently from those illustrated, for example, as strips extending longitudinally along the filter housing 110, or they may be provided on the wall of the pressure vessel 200. It is also possible to place an extra housing around the filter housing 110 and the spacers 160, thereby forming a feed-through conduit 150 between said housing and the filter housing 110.

In addition to improving the supply of liquid to be filtered to the various membrane modules in a pressure vessel, cleaning of the membrane modules in the pressure vessel by reversing the liquid flow is also clearly improved. To this end, flushing liquid is fed via the filtrate connection 220 and the permeate discharge compartments 140 to the capillary filtration membranes 121. The contamination that is retained in and/or on the membrane wall when filtering, is now flushed from and/or off the membrane wall, to be discharged through the capillary filtration membranes 121.

The contamination is subsequently further discharged from the pressure vessel, in flushing direction, through a following membrane module. Advantageously, the contamination does not need to pass through the capillary filtration membranes of a following membrane module, which would render cleaning more difficult, as is the case with membrane modules according to the prior art.

The walls of the feed-through conduit 150 coming into contact with the membrane compartment may be manufactured from a porous material of from the same material as the capillary filtration membranes. In the latter case, this suggests that, for the embodiment shown in FIG. 3, a tubular filtration membrane having a large diameter is used, which in this case serves mainly as feed-through conduit. In accordance with the illustrated embodiments, however, the walls of the feed-through conduits 150 preferably are made from a rigid material to provide good mechanical stability. Such a material is impermeable and has a smooth surface, so that accretion of solids is prevented to a large degree. Such accretion would have an adverse effect on the flow resistance of the feed-through conduits.

The filter housing, the discharge compartment, the feed-through conduits, and the like should be manufactured from a material that is inert to the medium to be filtered. This material may, for example, be a plastic such as PVC or nylon, but a metal or other material is also possible. Generally, however, a suitable plastic is preferred, since this can be processed less expensively.

Thus, the present invention, in distinction from many known devices, is an axial flow type of module, in which the fluid enters the core of the fibers and permeates through from the inside of the fibers to the outside. Furthermore, many known devices do not offer a feed-through conduit. The feed-through conduits 150 of the present invention permit some fluid to bypass a particular membrane module entirely to be passed on to the next, i.e., the fluid is fed to the next module through the current module and thereby avoiding the membrane area. Many current devices merely communicate permeate which has passed through the membranes of a particular module to flow to the next module from a permeate discharge. The axial flow of present invention with feed-through conduits permits the inventive apparatus to be operated at low pressure (about 10 psig).

The embodiments described above must not be under stood as restrictions on the invention. The filtration membrane module may be realized in a variety of embodiments all within the scope of the present invention and the appended claims, and although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

We claim:

1. A filtering apparatus comprising a pressure vessel having a feed connection and a filtrate connection, and at least one capillary filtration membrane module, said membrane module having a length and comprising an inlet coupled with the feed connection, an outlet coupled with the filtrate connection, and a filter housing defining a membrane compartment accommodating a bundle of capillary filtration membranes, and said capillary filtration membranes being cased at both ends of the membrane module in membrane holders, wherein at least one of the membrane modules comprises at least one feed-through conduit extending substantially in the longitudinal direction throughout the length of the membrane module, wherein walls of said feed-through conduit comprise an impermeable material, and wherein filtration flow occurs radially from inside each capillary filtration membrane to outside each said capillary filtration membrane.

2. A filtering apparatus according to claim 1 wherein at least one of said feed-through conduits comprises a pipe located inside the membrane compartment.

3. A filtering apparatus according to claim 1 additionally comprising a feed-through conduit annularly surrounding the membrane compartment.

4. A filtering apparatus according to claim 1, comprising a plurality of membrane modules in fluid serial connection.

5. A filtering apparatus according to claim 3 wherein walls of the annular feed-through conduit are formed by the filter housing and a wall of the pressure vessel.

6. A filtering apparatus according to claim 5 additionally comprising spacers between the wall of the pressure vessel and the filter housing.

7. A filtering apparatus according to claim 1 wherein walls of said feed-through conduit comprise a rigid material with a smooth surface.
